(19) United States
(12) Patent Application Publication
(10) Pub. No.: US 2003/0226525 A1
(43) Pub. Date: Dec. 11, 2003

(54) Warren cycle internal combustion engine with heat exchanger

(76) Inventor: Edward Lawrence Warren, West Melbourne, FL (US)

Correspondence Address: Edward L. Warren, 3912 Snowy Egret Dr., West Melbourne, FL, 32904, US

(21) Appl. No.: 10/166,911

(22) Filed: Jun. 11, 2002

(51) Int. Cl. F02B 75/02

(52) U.S. Cl. 123/65 R

(57) ABSTRACT

The Warren Cycle engine is an engine that has one heat exchanger (high-pressure side 10 and low-pressure side 20) serving four cylinders 100, 200, 300 and 400. The Warren Cycle is an engine cycle where compression is adiabatic, heat is added at constant volume, expansion is adiabatic and complete, and the exhaust heat is captured and returned to the compressed air. Movable wall 104 is provided to take in cold air and push exhaust air out of cylinder 100. As the exhaust moves out of the engine, it gives up heat to low-pressure side of heat exchanger 20. During the heating portion of the cycle, the compressed air gains heat from high-pressure side of heat exchanger 10. The engine can be operated with complete expansion of the heated charge.

### BACKGROUND

1. Field of Invention

The present invention relates to a reciprocating, two stroke internal combustion engine with four cylinders and one heat exchanger that transfers the heat from the exhaust to the compressed working fluid. The engine also has a compression ratio different from the expansion ratio to allow complete expansion.

2. Description of Prior Art

The Warren Cycle Engine is a regenerated engine similar to the Stirling Cycle Engine, which is one of the more efficient of the practical engines, but its compression ratio is the same as its expansion ratio therefore it has a problem with under expansion of the charge. The Warren Cycle Engine solves this problem by making the compression ratio different from the expansion ratio. Complete expansion is achieved by having a cooled volume much smaller than the heated volume. The present invention achieves complete expansion by taking in less air than will fill the volume of cylinder 100. Positioning movable wall 104 so that the desired amount of air is in cylinder 100 when power piston 106 recovers air inlet port 102 does this. This causes the volume of the cooled air about to be compressed to be smaller than the volume of the expanded air.

Previous engines also had trouble with the sizing of the regenerators. Both the high-pressure fluid and the low-pressure fluid used the same passages. What was the correct size for one was a problem for the other. The present invention uses a heat exchanger where each side can be sized for the fluid moving through it.

Previous engines used one regenerator per cylinder. The present invention uses only one heat exchanger for all four cylinders.

### SUMMARY

The Warren cycle engine is the mechanization of the Warren Cycle. The Warren Cycle is an engine cycle where compression is adiabatic, heat is added at constant volume, expansion is adiabatic and complete, and the exhaust heat is transferred to the compressed air. The result is a two stroke, internal combustion, reciprocating, heat exchanging engine made up of heat exchanger high-pressure side 10, heat exchanger low-pressure side 20, and four similar working cylinders. Each cylinder 100, 200, 300, 400 is closed at one end and contains power pistons 106, 206, 306, 406 that are connected to power output shaft 50. Movable walls 104, 204, 304, 404 are provided to take in the working fluid and push the exhaust out. As the exhaust moves out of cylinder 100, its heat is transferred from heat exchanger low-pressure side 20 to heat exchanger high-pressure side 10 and to the compressed fluid of cylinder 300. During the heating portion of the cycle movable wall 304 pushes the compressed fluid through heat exchanger high-pressure side 10 where the air is preheated. The air then moves back again into cylinder 300 where fuel is added and ignited. Movable wall 104 can move between power piston 106 and the top of cylinder 100. Up movement wall cam 110, down movement wall cam 112 and rocker arm 124 are provided to accomplish this movement at the appropriate times during the engine's operating cycle. Movable wall 104 is positioned so that the desired amount of air is in cylinder 100 at the time air inlet port 102 is recovered. This determines the engines power output and efficiency. In an alternate embodiment of this invention the engine operates with only two cylinders.

### OBJECTS AND ADVANTAGES

The advantage of the Warren Cycle Internal Combustion Engine With Heat Exchanger is that it operates on the Warren Cycle.

Another advantage of the Warren Cycle Internal Combustion Engine With Heat Exchanger is it can use the exhaust heat of all four cylinders to preheat the compressed fluid using only one heat exchanger.

Another advantage of the Warren Cycle Internal Combustion Engine With Heat Exchanger is that it can be operated so that the charge is fully expanded.

### DRAWING FIGURES

FIG. 1 shows the engine with the first cylinder, cylinder 100, at the end of the expansion part of the cycle, and at the start of the inlet and exhaust part of the cycle.

FIG. 2 shows the engine with the first cylinder, cylinder 100, at the end of the inlet and exhaust part of the cycle, and at the start of the compression part of the cycle.

FIG. 3 shows the engine with the first cylinder, cylinder 100, at the end of the compression part of the cycle, and at the start of the heating part of the cycle.

FIG. 4 shows the engine with the first cylinder, cylinder 100, at the end of the heating part of the cycle, and at the start of the expansion part of the cycle.

FIG. 5 shows the first alternate embodiment of the engine with the first cylinder, cylinder 100, at the end of the expansion part of the cycle, and at the start of the inlet and exhaust part of the cycle.

FIG. 6 shows the first alternate embodiment of the engine with the first cylinder, cylinder 100, at the end of the inlet and exhaust part of the cycle, and at the start of compression part of the cycle.

FIG. 7 shows the first alternate embodiment of the engine with the first cylinder, cylinder 100, at the end of the compression part of the cycle, and at the start of the heating part of the cycle.

FIG. 8 shows the first alternate embodiment of the engine with the first cylinder, cylinder 100, at the end of the heating part of the cycle, and at the start of the expansion part of the cycle.

REFERENCE NUMERALS IN DRAWINGS

| | | | | |
|---|---|---|---|---|
| heat exchanger high-pressure side | 10 | | | |
| heat exchanger low-pressure side | 20 | | | |
| exhaust pipe | 30 | | | |
| power output shaft | 50 | | | |
| crankcase | 60 | | | |
| cylinder | 100 | 200 | 300 | 400 |
| air inlet port | 102 | 202 | 302 | 402 |
| movable wall | 104 | 204 | 304 | 404 |
| power piston | 106 | 206 | 306 | 406 |
| connecting rod | 108 | 208 | 308 | 408 |
| up movement wall cam | 110 | 210 | 310 | 410 |
| down movement wall cam | 112 | 212 | 312 | 412 |
| heated air valve | 114 | 214 | 314 | 414 |
| low-pressure heat exchanger inlet valve | 116 | 216 | 316 | 416 |
| high-pressure heat exchanger inlet valve | 118 | 218 | 318 | 418 |
| compression ratio valve | 120 | | 320 | |
| push rod | 122 | 222 | 322 | 422 |
| rocker arm | 124 | 224 | 324 | 424 |
| valve cams | 126 | 226 | 326 | 426 |
| fuel injector | 128 | 228 | 328 | 428 |
| igniter | 130 | 230 | 330 | 430 |

### Description

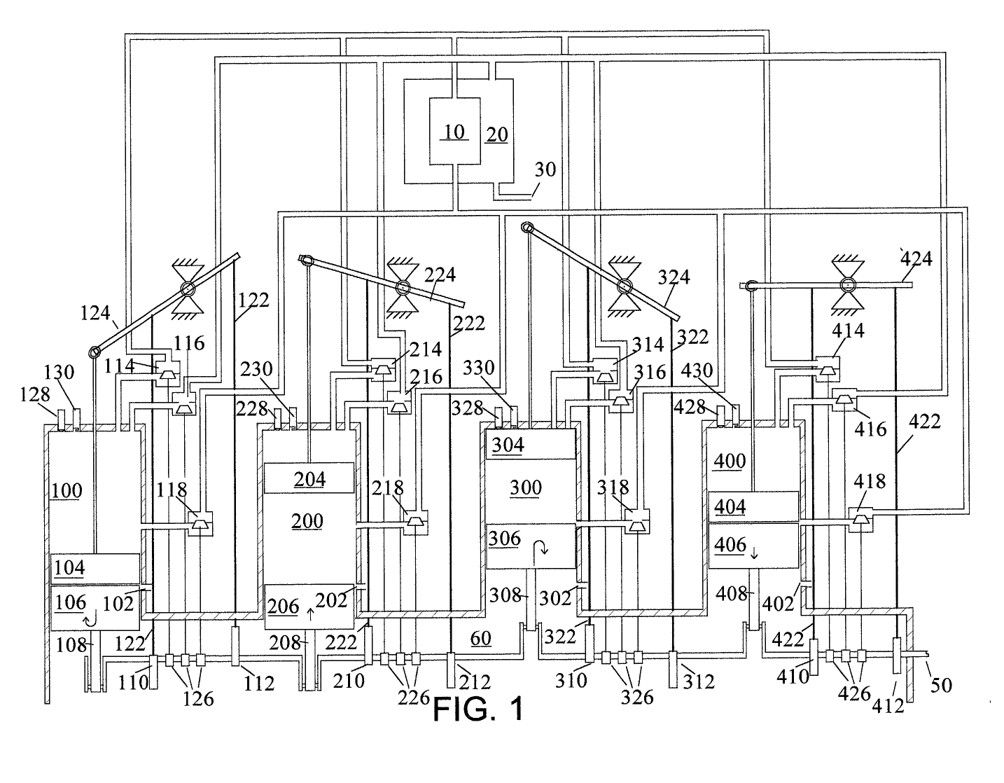

### FIGS. 1 to 4

### Preferred Embodiment

This invention is a two stroke, reciprocating, internal combustion engine with four cylinders 100, 200, 300, 400, exhaust pipe 30, power output shaft 50, crankcase 60, heat exchanger high-pressure side 10, and heat exchanger low-pressure side 20. The invention employs a two-stroke cycle divided into four parts. The first part is the intake and the exhaust part, the second is the compression part, the third is the heating part, and the fourth is the expansion part. The intake and exhaust part is from about 85% of the downward travel of power pistons 106, 206, 306, 406 to about 15% of the travel back up (or as measured by power output shaft 50 rotation from about 135° to about (225°). The compression part is from about 15% of the travel back up of power pistons 106, 206, 306, 406 (225°) to about top dead center. The heating part is from about 85% of the travel back up of power pistons 106, 206, 306, 406 (315°) to about 15% of the downward travel of power pistons 106, 206, 306, 406 (45°). The expansion part is from about top dead center to about 85% of the downward travel of power pistons 106, 206, 306, 406 (135°). The heating part of the cycle overlaps both the end of the compression part and the start of the expansion part of the cycle. The compression ratio adjustment is part of the air intake and exhaust part of the cycle. The above positions are all estimates and are given for descriptive purposes only. The actual position a part of the cycle may begin or end at may be different from those set out above.

Cylinders 100, 200, 300, 400 contain movable walls 104, 204, 304, 404, power pistons 106, 206, 306, 406, and connecting rods 108, 208, 308, 408. Connecting rods 108, 208, 308, 408 are connected to power output shaft 50, which operates valve cams 126, 226, 326, 426, up movement wall cams 110, 210, 310, 410, and down movement wall cams 112, 212, 312, 412. Up movement wall cams 110, 210, 310, 410, and down movement wall cams 112, 212, 312, 412 move rocker arms 124, 224, 324, 424 which move movable walls 104, 204, 304, 404 respectively.

Heat exchanger high-pressure side 10, heat exchanger low-pressure side 20, and power output shaft 50 are attached to cylinders 100, 200, 300, 400. Also attached to cylinders 100, 200, 300, 400 are air inlet ports 102, 202, 302, 402, heated air valves 114, 214, 314, 414, low-pressure heat exchanger inlet valves 116, 216, 316, 416, and high-pressure heat exchanger inlet valves 118, 218, 318, 418, respectively. Heated air valves 114, 214, 314, 414 control the air flow out of heat exchanger high-pressure side 10. Low-pressure heat exchanger inlet valves 116, 216, 316, 416 control the air flow into heat exchanger low-pressure side 20. High-pressure heat exchanger inlet valves 118, 218, 318, 418 control the air flow into heat exchanger high-pressure side 10.

Air inlet ports 102, 202, 302, 402 allow air into cylinders 100, 200, 300, 400 respectively. Heat exchanger low-pressure side 20 transfers exhaust heat to the compressed air in heat exchanger high-pressure side 10. Movable walls 104, 204, 304, 404 take in air and push exhaust out through heat exchanger low-pressure side 20 and exhaust pipe 30 during the intake and exhaust part of the cycle. Movable walls 104, 204, 304, 404 also move air from between power pistons 106, 206, 306, 406 and themselves through heat exchanger high-pressure side 10 and into the top of cylinders 100, 200, 300, 400 during the heating part of the cycle.

Fuel is injected by fuel injectors 128, 228, 328, 428, and ignited by the hot air or by igniters 130, 230, 330, 430. Power pistons 106, 206, 306, 406, along with connecting rods 108, 208, 308, 408 and power output shaft 50 transfer work from the hot expanding air to a power takeoff device not shown. Up movement wall cams 110, 210, 310, 410, push rods 122, 222, 322, 422, and rocker arms 124, 224, 324, 424 move movable walls 104, 204, 304, 404 up during the air intake and exhaust part of the cycle. Down movement wall cams 112, 212, 312, 412, push rods 122, 222, 322, 422, and rocker arms 124, 224, 324, 424 move movable walls 104, 204, 304, 404 down during the heating and expansion parts of the cycle. Valve cams 126, 226, 326, 426 and springs not shown open and close valves.

Air is expected to be employed as the working fluid in this engine. However, the working fluid could be any mixture of gases, liquids, and solids that can be ignited and burned. After heating the working fluid is referred to as spent working fluid or exhaust. Movable walls 104, 204, 304, 404 are shown being moved by cams, electric or hydraulic actuators (not shown) can also move them.

### Operation

### FIGS. 1 to 4

### Preferred Embodiment

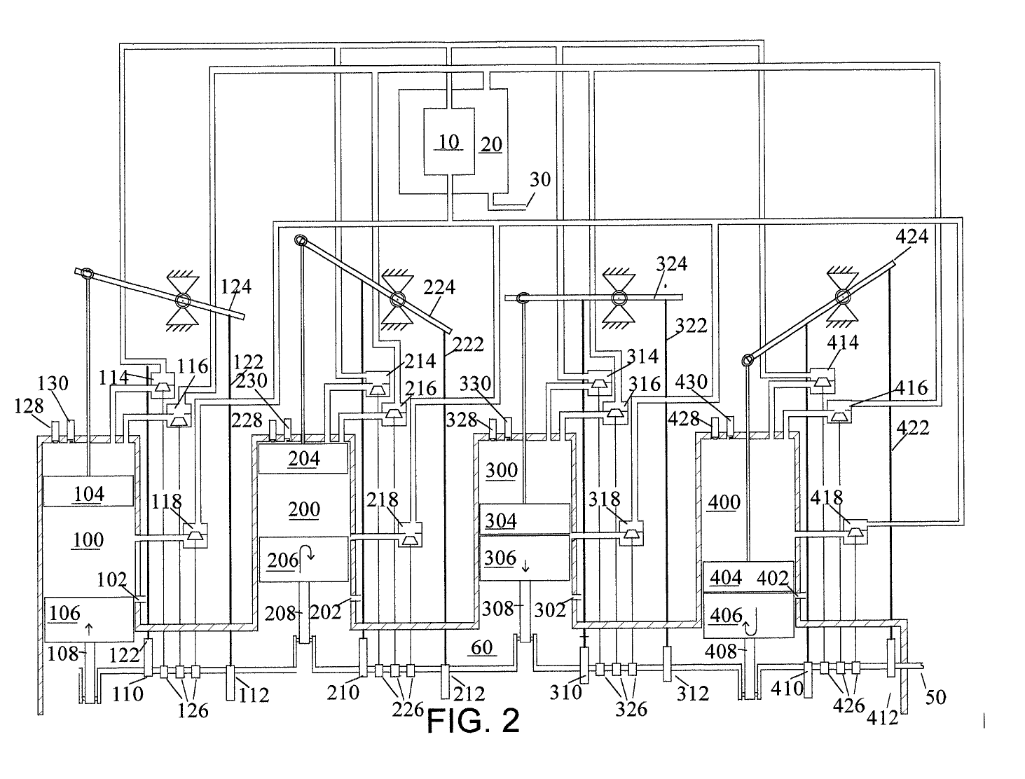

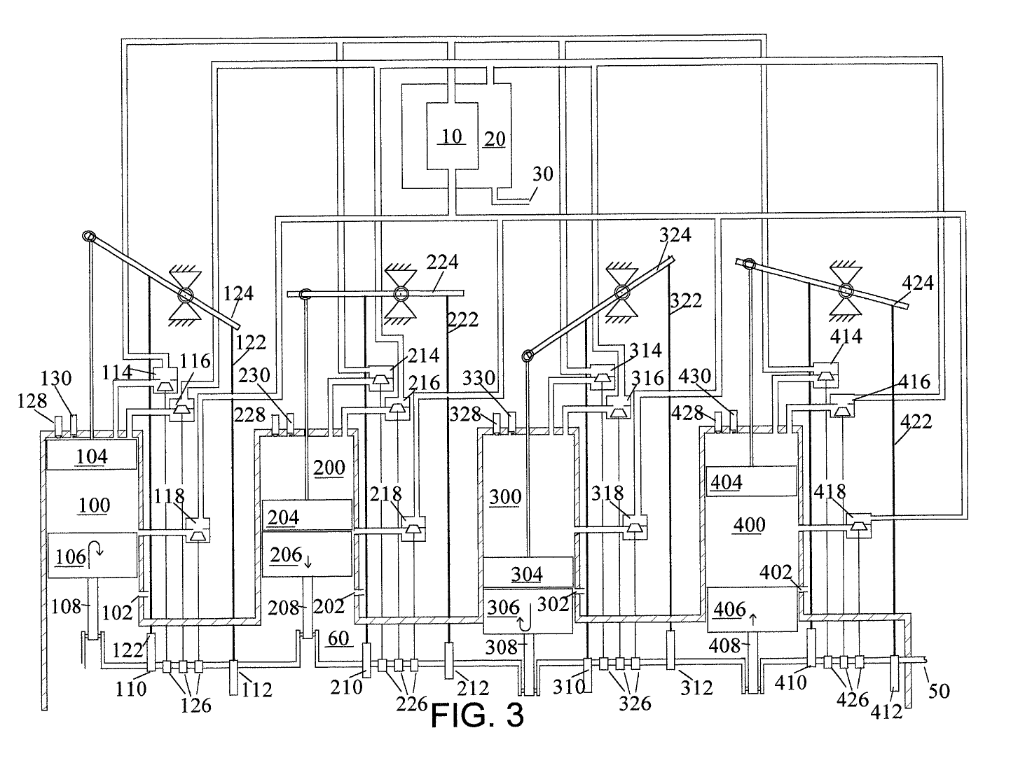

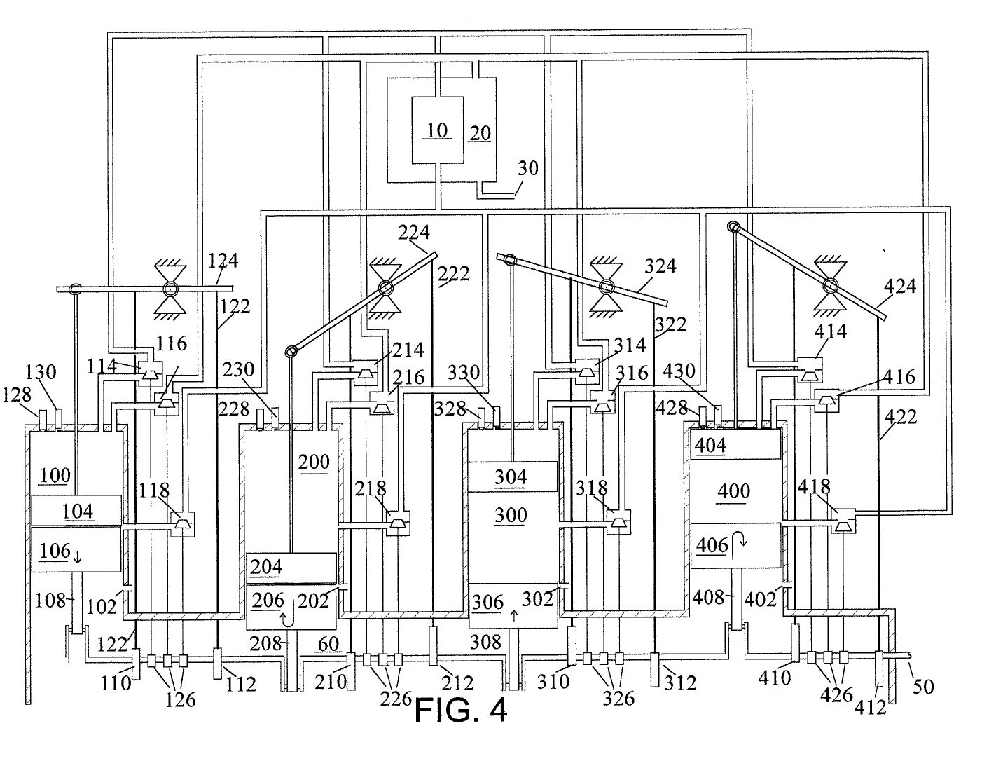

FIGS. 1 to 4 present the sequence of steps or processes occurring in the engine. For cylinder 100, the air intake and exhaust part of the cycle takes place between FIGS. 1 and 2. The compression part of the cycle takes place between FIGS. 2 and 3. The heating part of the cycle takes place between FIGS. 3 and 4. The expansion part of the cycle takes place between FIGS. 4 and 1.

For cylinder 200, the air intake and exhaust part of the cycle takes place between FIGS. 4 and 1. The compression part of the cycle takes place between FIGS. 1 and 2. The heating part of the cycle takes place between FIGS. 2 and 3. The expansion part of the cycle takes place between FIGS. 3 and 4.

For cylinder 300, the air intake and exhaust part of the cycle takes place between FIGS. 3 and 4. The compression part of the cycle takes place between FIGS. 4 and 1. The heating part of the cycle takes place between FIGS. 1 and 2. The expansion part of the cycle takes place between FIGS. 2 and 3.

For cylinder 400, the air intake and exhaust part of the cycle takes place between FIGS. 2 and 3. The compression part of the cycle takes place between FIGS. 3 and 4. The heating part of the cycle takes place between FIGS. 4 and 1. The expansion part of the cycle takes place between FIGS. 1 and 2 FIG. 1 shows power piston 106 at about 85% of downward travel (135°). Cylinder 100 has completed the expansion part of the cycle and is about to start the intake and exhaust part. Air inlet port 102 is being uncovered, heated air valve 114 is closed, low-pressure heat exchanger inlet valve 116 is starting open, high-pressure heat exchanger inlet valve 118 is closed, and movable wall 104 is just above power piston 106.

In cylinder 200 there is a charge of fresh air between movable wall 204 and power piston 206 which is at about 15% of its upward travel (225°). Air inlet port 202 has just been recovered, heated air valve 214 is closed, low-pressure heat exchanger inlet valve 216 is open, high-pressure heat exchanger inlet valve 218 is closed, and movable wall 204 is moving to the top of cylinder 200.

In cylinder 300, power piston 306 is at about 85% of its upward travel (315°). Heated air valve 314, is opening, low-pressure heat exchanger inlet valve 316 is closed, high-pressure heat exchanger inlet valve 318 is opening, and movable wall 304 is adjacent to the top of cylinder 300.

In cylinder 400, power piston 406 is at about 15% of its downward travel (45°). Heated air valve 414, is closing, low-pressure heat exchanger inlet valve 416 is closed, high-pressure heat exchanger inlet valve 418 is closing, and movable wall 404 is adjacent to the top of power piston 406.

Between FIG. 1 and FIG. 2, in cylinder 100 air intake and exhaust is taking place. Air inlet port 102 is uncovered, heated air valve 114 is closed, low-pressure heat exchanger inlet valve 116 is open, high-pressure heat exchanger inlet valve 118 is closed. Movable wall 104 moves up in cylinder 100. While movable wall 104 is moving up exhaust gases are moving through heat exchanger low-pressure side 20 and cooling while heating up heat exchanger high-pressure side 10 on their way out exhaust pipe 30. Also while movable wall 104 is moving up, it takes in fresh air through air inlet port 102 until the correct amount of air is in cylinder 100. Power piston 106 continues down to the bottom of cylinder 100 and comes up again to about 15% of upward travel of power piston 106 (225°).

In cylinder 200 compression takes place. Air inlet port 202 is recovered, heated air valve 214, is closed, movable wall 204 moves adjacent to the top of cylinder 200, low-pressure heat exchanger inlet valve 216 closes when movable wall 204 reaches the top of cylinder 200, and high-pressure heat exchanger inlet valve 218 is closed. Power piston 206 continues up in cylinder 200 to about 85% of its upward travel (225°).

In cylinder 300 heating takes place. Heated air valve 314 is open, low-pressure heat exchanger inlet valve 316 is closed, high-pressure heat exchanger inlet valve 318 is open, and movable wall 304 moves adjacent to the top of power piston 306. While movable wall 304 is moving down to the top of power piston 306 compressed air heats up as it is forced though heat exchanger high-pressure side 10 and is heated further by burning fuel after it reenters cylinder 300. Power piston 306 continues up then down in cylinder 300 until about 15% of its downward travel (45°).

In cylinder 400 expansion takes place. Heated air valve 414 is closed, low-pressure heat exchanger inlet valve 416 is closed, high-pressure heat exchanger inlet valve 418 is closed, and movable wall 404 is adjacent to the top of power piston 406. Power piston 406 and movable wall 404 move down to about 85% of power piston's 406 downward travel (135°) as power output takes place.

FIG. 2 shows there is a charge of fresh air in cylinder 100 between movable wall 104 and power piston 106 which is at about 15% of its upward travel (225°). Air inlet port 102 has just been recovered, heated air valve 114, is closed, low-pressure heat exchanger inlet valve 116 is open, high-pressure heat exchanger inlet valve 118 is closed, and movable wall 104 is moving to the top of cylinder 100.

In cylinder 200, power piston 206 is at about 85% of its upward travel (315°). Heated air valve 214 is opening, low-pressure heat exchanger inlet valve 216 is closed, high-pressure heat exchanger inlet valve 218 is opening, and movable wall 204 is adjacent to the top of cylinder 200.

In cylinder 300, power piston 306 is at about 15% of its downward travel (45°). Heated air valve 314 is closing, low-pressure heat exchanger inlet valve 316 is closed, high-pressure heat exchanger inlet valve 318 is closing, and movable wall 304 is adjacent to the top of power piston 306.

In cylinder 400, power piston 406 is at about 85% of downward travel (135°). Cylinder 400 has completed the expansion part of the cycle and is about to start the intake and exhaust part. Air inlet port 402 is being uncovered, heated air valve 414, is closed, low-pressure heat exchanger inlet valve 416 is starting open, high-pressure heat exchanger inlet valve 418 is closed, and movable wall 404 is just above power piston 406.

Between FIG. 2 and FIG. 3, in cylinder 100 compression takes place. Air inlet port 102 is recovered, heated air valve 114 is closed, movable wall 104 moves adjacent to the top of cylinder 100, low-pressure heat exchanger inlet valve 116 closes when movable wall 104 reaches the top of cylinder 100, and high-pressure heat exchanger inlet valve 118 is closed. Power piston 106 continues up in cylinder 100 to about 85% of its upward travel (225°).

In cylinder 200 heating takes place. Heated air valve 214 is open, low-pressure heat exchanger inlet valve 216 is closed, high-pressure heat exchanger inlet valve 218 is open, and movable wall 204 moves adjacent to the top of power piston 206. While movable wall 204 is moving down to the top of power piston 206 compressed air heats up as it is forced though heat exchanger high-pressure side 10 and is heated further by burning fuel after it reenters cylinder 200. Power piston 206 continues up then down in cylinder 200 until about 15% of its downward travel (45°).

In cylinder 300 expansion takes place. Heated air valve 314 is closed, low-pressure heat exchanger inlet valve 316 is closed, high-pressure heat exchanger inlet valve 318 is closed, and movable wall 304 is adjacent to the top of power piston 306. Power piston 306 and movable wall 304 move down to about 85% of power piston's 306 downward travel (135°) as power output takes place.

In cylinder 400 air intake and exhaust is taking place. Air inlet port 402 is uncovered, heated air valve 414 is closed, low-pressure heat exchanger inlet valve 416 is open, high-pressure heat exchanger inlet valve 418 is closed, and movable wall 404 moves up in cylinder 400. While movable wall 404 is moving up exhaust gases are moving through heat exchanger low-pressure side 20 and cooling while heating up heat exchanger high-pressure side 10 on their way out exhaust pipe 30. Also while movable wall 404 is moving up, it takes in fresh air through air inlet port 402 until the correct amount of air is in cylinder 400. Power piston 406 continues down to the bottom of cylinder 400 and comes up again to about 15% of its upward travel (225°).

FIG. 3 shows that in cylinder 100 power piston 106 is at about 85% of its upward travel (315°). Heated air valve 114 is opening, low-pressure heat exchanger inlet valve 116 is closed, high-pressure heat exchanger inlet valve 118 is opening, and movable wall 104 is adjacent to the top of cylinder 100.

In cylinder 200, power piston 206 is at about 15% of its downward travel (45°). Heated air valve 214, is closing, low-pressure heat exchanger inlet valve 216 is closed, high-pressure heat exchanger inlet valve 218 is closing, and movable wall 204 is adjacent to the top of power piston 206.

In cylinder 300, power piston 306 is at about 85% of downward travel (135°). Cylinder 300 has completed the expansion part of the cycle and is about to start the intake and exhaust part. Air inlet port 302 is being uncovered, heated air valve 314 is closed, low-pressure heat exchanger inlet valve 316 is starting to open, high-pressure heat exchanger inlet valve 318 is closed, and movable wall 304 is just above power piston 306.

In cylinder 400, there is a charge of fresh air between movable wall 404 and power piston 406 which is at about 15% of its upward travel (225°). Air inlet port 402 has just been recovered, heated air valve 414 is closed, low-pressure heat exchanger inlet valve 416 is open, high-pressure heat exchanger inlet valve 418 is closed, and movable wall 404 is moving to the top of cylinder 400.

Between FIG. 3 and FIG. 4, in cylinder 100 heating takes place. Heated air valve 114 is open, low-pressure heat exchanger inlet valve 116 is closed, high-pressure heat exchanger inlet valve 118 is open, and movable wall 104 moves adjacent to the top of power piston 106. While movable wall 104 is moving down to the top of power piston 106 compressed air heats up as it is forced though heat exchanger high-pressure side 10 and is heated further by burning fuel after it reenters cylinder 100 Power piston 106 continues up then down in cylinder 100 until about 15% of its downward travel (45°).

In cylinder 200 expansion takes place. Heated air valve 214 is closed, low-pressure heat exchanger inlet valve 216 is closed, high-pressure heat exchanger inlet valve 218 is closed, and movable wall 204 is adjacent to the top of power piston 206. Power piston 206 and movable wall 204 move down to about 85% of power piston's 206 downward travel (135°) as power output takes place.

In cylinder 300 air intake and exhaust is taking place. Air inlet port 302 is uncovered, heated air valve 314 is closed, low-pressure heat exchanger inlet valve 316 is open, high-pressure heat exchanger inlet valve 318 is closed, and movable wall 304 moves up in cylinder 300. While movable wall 304 is moving up exhaust gases are moving through heat exchanger low-pressure side 20 and cooling while heating up heat exchanger high-pressure side 10 on their way out exhaust pipe 30. Also while movable wall 304 is moving up, it takes in fresh air through air inlet port 302 until the correct amount of air is in cylinder 300. Power piston 306 continues down to the bottom of cylinder 300 and comes up again to about 15% of its upward travel (225°).

In cylinder 400 compression takes place. Air inlet port 402 is recovered, heated air valve 414 is closed, movable wall 404 moves adjacent to the top of cylinder 400, low-pressure heat exchanger inlet valve 416 closes when movable wall 404 reaches the top of cylinder 400, and high-pressure heat exchanger inlet valve 418 is closed. Power piston 406 continues up in cylinder 400 to about 85% of its upward travel (225°).

FIG. 4 shows that in cylinder 100 power piston 106 is at about 15% of its downward travel (45°). Heated air valve 114 is closing, low-pressure heat exchanger inlet valve 116 is closed, high-pressure heat exchanger inlet valve 118 is closing, and movable wall 104 is moving to the top of power piston 106.

In cylinder 200, power piston 206 is at about 85% of downward travel (135°). Cylinder 200 has completed the expansion part of the cycle and is about to start the intake and exhaust part. Air inlet port 202 is being uncovered, heated air valve 214 is closed, low-pressure heat exchanger inlet valve 216 is starting to open, high-pressure heat exchanger inlet valve 218 is closed, and movable wall 204 is just above power piston 206.

In cylinder 300, there is a charge of fresh air between movable wall 304 and power piston 306 which is at about 15% of its upward travel (225°). Air inlet port 302 has just been recovered, heated air valve 314 is closed, low-pressure heat exchanger inlet valve 316 is open, high-pressure heat exchanger inlet valve 318 is closed, and movable wall 304 is moving to the top of cylinder 300

In cylinder 400, Heated air valve 414 is opening, low-pressure heat exchanger inlet valve 416 is closed, high-pressure heat exchanger inlet valve 418 is opening, and movable wall 404 is adjacent to the top of cylinder 400.

Between FIG. 4 and FIG. 1, in cylinder 100 expansion takes place. Heated air valve 114 is closed, low-pressure heat exchanger inlet valve 116 is closed, high-pressure heat exchanger inlet valve 118 is closed, and movable wall 104 is adjacent to the top of power piston 106. Power piston 106 and movable wall 104 move down to about 85% of power piston's 106 downward travel (135°), as power output takes place.

In cylinder 200 air intake and exhaust is taking place. Air inlet port 202 is uncovered, heated air valve 214 is closed, low-pressure heat exchanger inlet valve 216 is open, high-pressure heat exchanger inlet valve 218 is closed, and movable wall 204 moves up in cylinder 200. While movable wall 204 is moving up exhaust gases are moving through heat exchanger low-pressure side 20 and cooling while heating up heat exchanger high-pressure side 10 on their way out exhaust pipe 30. Also while movable wall 204 is moving up it takes in fresh air through air inlet port 202 until the correct amount of air is in cylinder 200. Power piston 206 continues down to the bottom of cylinder 200 and comes up again to about 15% of its upward travel (225°).

In cylinder 300 compression takes place. Air inlet port 302 is recovered, heated air valve 314 is closed, movable wall 304 moves adjacent to the top of cylinder 300, low-pressure heat exchanger inlet valve 316 closes when movable wall 304 reaches the top of cylinder 300, and high-pressure heat exchanger inlet valve 318 is closed. Power piston 306 continues up in cylinder 300 to about 85% of its upward travel (225°).

In cylinder 400 heating takes place. Heated air valve 414 is open, low-pressure heat exchanger inlet valve 416 is closed, high-pressure heat exchanger inlet valve 418 is open, and movable wall 404 moves adjacent to the top of power piston 406. While movable wall 404 is moving down to the top of power piston 406 compressed air heats up as it is forced though heat exchanger high-pressure side 10 and is heated further by burning fuel after it reenters cylinder 400. Power piston 406 continues up then down in cylinder 400 until about 15% of its downward travel (45°).

### Description

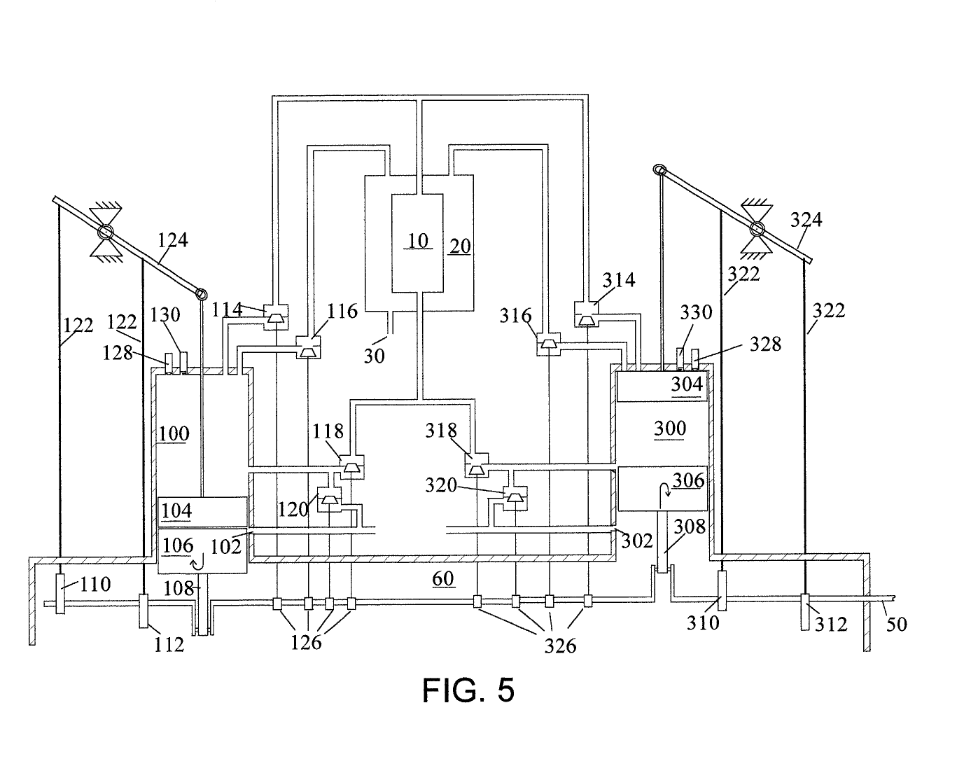

### FIGS. 5 to 8

### First Alternate Embodiment of the Invention

The first alternate embodiment of the invention is a two stroke, reciprocating, internal combustion engine with two cylinders 100 and 300, exhaust pipe 30, power output shaft 50, crankcase 60, heat exchanger high-pressure side 10, and heat exchanger low-pressure side 20. The invention employs a two-stroke cycle divided into four parts. The first part is the intake and the exhaust part, the second is the compression part, the third is the heating part, and the fourth is the expansion part. The intake and exhaust part is from about 85% of the downward travel of power pistons 106 and 306 to about 15% of the travel back up (or as measured by power output shaft 50 rotation from about 135° to about (225°). The compression part is from about 15% of the travel back up of power pistons 106, and 306 (225°) to about top dead center. The heating part is from about 85% of the travel back up of power pistons 106 and 306 (315°) to about 15% of the downward travel of power pistons 106 and 306 (45°). The expansion part is from about top dead center to about 85% of the downward travel of power pistons 106 and 306 (135°). The heating part of the cycle overlaps both the end of the compression part and the start of the expansion part of the cycle. The compression ratio adjustment is part of the air compression part of the cycle. The above positions are all estimates and are given for descriptive purposes only. The actual position a part of the cycle may begin or end at may be different from those set out above.

Cylinders 100 and 300 contain movable walls 104 and 304, power pistons 106 and 306, and connecting rods 108 and 308. Connecting rods 108 and 308 are connected to power output shaft 50, which operates valve cams 126 and 326, up movement wall cams 110 and 310, and down movement wall cams 112 and 312. Up movement wall cams 110 and 310, and down movement wall cams 112 and 312 move rocker arms 124 and 324 which move movable walls 104 and 304 respectively.

Heat exchanger high-pressure side 10, heat exchanger low-pressure side 20, and power output shaft 50 are attached to cylinders 100 and 300. Also attached to cylinders 100 and 300 are air inlet ports 102 and 302, heated air valves 114 and 314, low-pressure heat exchanger inlet valves 116 and 316, and high-pressure heat exchanger inlet valves 118 and 318, respectively. Heated air valves 114 and 314 control the airflow out of heat exchanger high-pressure side 10. Low-pressure heat exchanger inlet valves 116 and 316 control the airflow into heat exchanger low-pressure side 20. High-pressure heat exchanger inlet valves 118 and 318 control the airflow into heat exchanger high-pressure side 10. Compression ratio valves 120 and 320 control the compression ratio of the engine. The compression ratio of the engine can be set different from the expansion ratio.

Air inlet ports 102 and 302 allow air into cylinders 100 and 300 respectively. Heat exchanger low-pressure side 20 transfers exhaust heat to the compressed air in heat exchanger high-pressure side 10. Movable walls 104 and 304 take in air and push exhaust out through heat exchanger low-pressure side 20 and exhaust pipe 30 during the intake and exhaust part of the cycle. Movable walls 104 and 304 also move air from between power pistons 106 and 306 and themselves through heat exchanger high-pressure side 10 into the top of cylinders 100 and 300 during the heating part of the cycle.

Fuel is injected by fuel injectors 128 and 328, and ignited by the hot air or by igniters 130 and 330. Power pistons 106 and 306 along with connecting rods 108 and 308 and power output shaft 50 transfer work from the hot expanding air to a power takeoff device not shown. Up movement wall cams 110 and 310, push rods 122 and 322, and rocker arms 124 and 324 move movable walls 104 and 304 up during the air intake and exhaust part of the cycle. Down movement wall cams 112 and 312, push rods 122 and 322, and rocker arms 124 and 324 move movable walls 104 and 304 down during the heating and expansion parts of the cycle. Valve cams 126 and 326 and springs not shown open and close valves.

### Operation

### FIGS. 5 to 8

### First Alternate Embodiment of the Invention

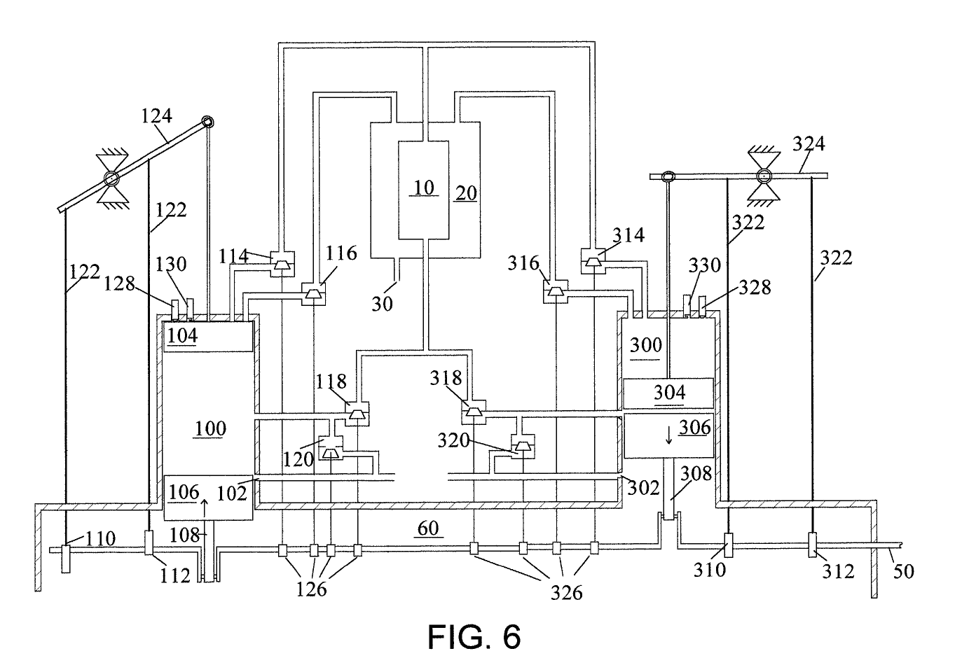

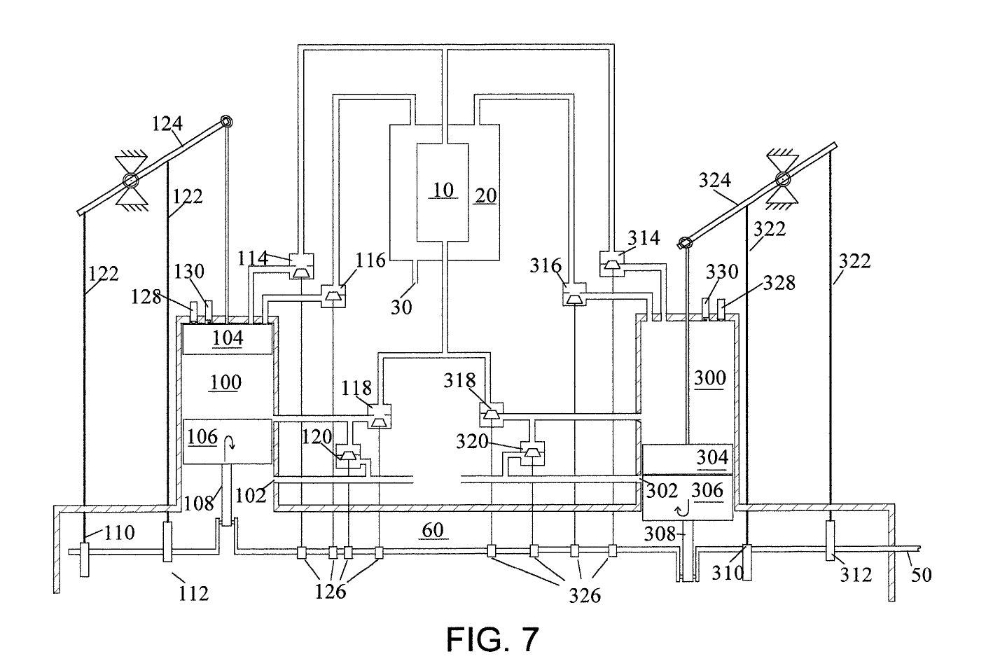

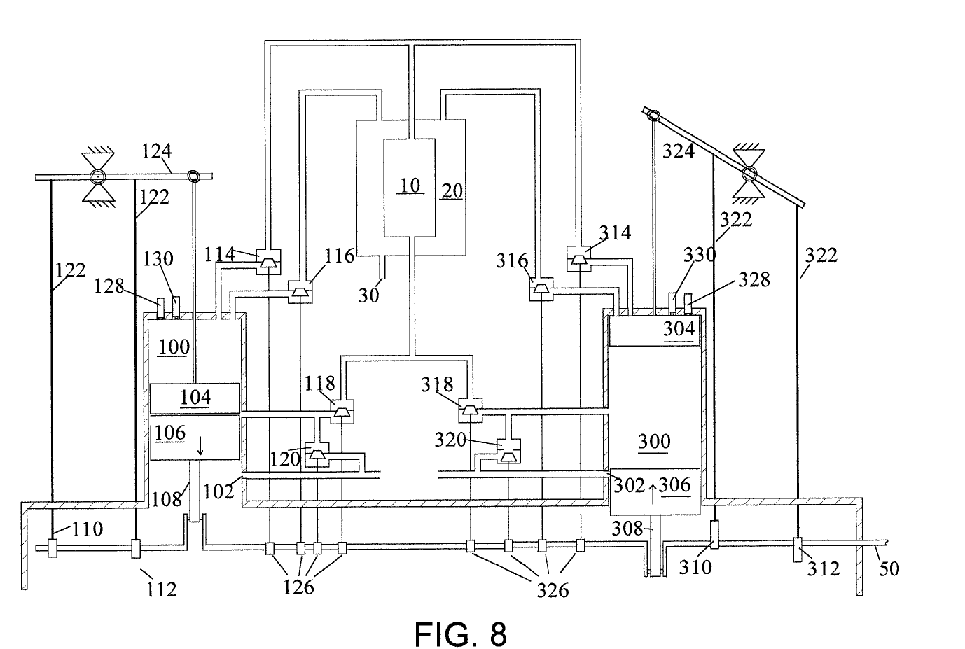

FIGS. 5 to 8 present the sequence of steps or processes occurring in the engine. For cylinder 100, the air intake and exhaust part of the cycle takes place between FIGS. 5 and 6. The compression part of the cycle takes place between FIGS. 6 and 7. The heating part of the cycle takes place between FIGS. 7 and 8. The expansion part of the cycle takes place between FIGS. 8 and 5.

For cylinder 300, the air intake and exhaust part of the cycle takes place between FIGS. 7 and 8. The compression part of the cycle takes place between FIGS. 8 and 5. The heating part of the cycle takes place between FIGS. 5 and 6. The expansion part of the cycle takes place between FIGS. 6 and 7.

FIG. 5 shows power piston 106 at about 85% of downward travel (135°). Cylinder 100 has completed the expansion part of the cycle and is about to start the intake and exhaust part. Air inlet port 102 is being uncovered, heated air valve 114 is closed, low-pressure heat exchanger inlet valve 116 is starting to open, high-pressure heat exchanger inlet valve 118 is closed, compression ratio valve 120 is closed, and movable wall 104 is just above power piston 106.

In cylinder 300, power piston 306 is at about 85% of its upward travel (315°). Heated air valve 314 is opening, low-pressure heat exchanger inlet valve 316 is closed, high-pressure heat exchanger inlet valve 318 is opening, compression ratio valve 320 is closed, and movable wall 304 is adjacent to the top of cylinder 300.

Between FIG. 5 and FIG. 6, in cylinder 100 air intake and exhaust is taking place. Air inlet port 102 is uncovered, heated air valve 114 is closed, low-pressure heat exchanger inlet valve 116 is open, high-pressure heat exchanger inlet valve 118 is closed, compression ratio valve 120 is closed, and movable wall 104 moves up to the top of cylinder 100. While movable wall 104 is moving up exhaust gases are moving through heat exchanger low-pressure side 20 and cooling while heating up heat exchanger high-pressure side 10 on their way out exhaust pipe 30. Also while movable wall 104 is moving up, it takes in fresh air through air inlet port 102. Power piston 106 continues down to the bottom of cylinder 100 and comes up again to about 15% of upward travel of power piston 106 (225°).

In cylinder 300 heating takes place. Heated air valve 314 is open, low-pressure heat exchanger inlet valve 316 is closed, high-pressure heat exchanger inlet valve 318 is open, compression ratio valve 320 is closed, and movable wall 304 moves adjacent to the top of power piston 306. While movable wall 304 is moving down to the top of power piston 306 compressed air heats up as it is forced though heat exchanger high-pressure side 10 and is heated further by burning fuel after it reenters cylinder 300. Power piston 306 continues up then down in cylinder 300 until about 15% of its downward travel (45°).

FIG. 6 shows there is a charge of fresh air in cylinder 100 between movable wall 104 and power piston 106 which is at about 15% of its upward travel (225°). Air inlet port 102 has just been recovered, heated air valve 114 is closed, low-pressure heat exchanger inlet valve 116 is closing, high-pressure heat exchanger inlet valve 118 is closed, compression ratio valve 120 is opening, and movable wall 104 is at the top of cylinder 100.

In cylinder 300, power piston 306 is at about 15% of its downward travel (45°). Heated air valve 314 is closing, low-pressure heat exchanger inlet valve 316 is closed, high-pressure heat exchanger inlet valve 318 is closing, compression ratio valve 320 is closed, and movable wall 304 is adjacent to the top of power piston 306.

Between FIG. 6 and FIG. 7, in cylinder 100 compression takes place. Air inlet port 102 is recovered, heated air valve 114 is closed, movable wall 104 is adjacent to the top of cylinder 100, low-pressure heat exchanger inlet valve 116 is closed, high-pressure heat exchanger inlet valve 118 is closed, and compression ratio valve 120 is open. Compression ratio valve 120 closes when the correct amount of air for the desired compression ratio is left in cylinder 100. Power piston 106 continues up in cylinder 100 to about 85% of its upward travel (225°).

In cylinder 300 expansion takes place. Heated air valve 314 is closed, low-pressure heat exchanger inlet valve 316 is closed, high-pressure heat exchanger inlet valve 318 is closed, compression ratio valve 320 is closed, and movable wall 304 is adjacent to the top of power piston 306. Power piston 306 and movable wall 304 move down to about 85% of power piston's 306 downward travel (135°) as power output takes place.

FIG. 7 shows that in cylinder 100 power piston 106 is at about 85% of its upward travel (315°). Heated air valve 114 is opening, low-pressure heat exchanger inlet valve 116 is closed, high-pressure heat exchanger inlet valve 118 is opening, compression ratio valve 120 is closed, and movable wall 104 is adjacent to the top of cylinder 100.

In cylinder 300, power piston 306 is at about 85% of downward travel (135°). Cylinder 300 has completed the expansion part of the cycle and is about to start the intake and exhaust part. Air inlet port 302 is being uncovered, heated air valve 314 is closed, low-pressure heat exchanger inlet valve 316 is starting to open, high-pressure heat exchanger inlet valve 318 is closed, compression ratio valve 320 is closed, and movable wall 304 is just above power piston 306.

Between FIG. 7 and FIG. 8, in cylinder 100 heating takes place. Heated air valve 114 is open, low-pressure heat exchanger inlet valve 116 is closed, high-pressure heat exchanger inlet valve 118 is open, compression ratio valve 120 is closed, and movable wall 104 moves adjacent to the top of power piston 106. While movable wall 104 is moving down to the top of power piston 106 compressed air heats up as it is forced though heat exchanger high-pressure side 10 and is heated further by burning fuel after it reenters cylinder 100. Power piston 106 continues up then down in cylinder 100 until about 15% of its downward travel (45°).

In cylinder 300 air intake and exhaust is taking place. Air inlet port 302 is uncovered, heated air valve 314 is closed, low-pressure heat exchanger inlet valve 316 is open, high-pressure heat exchanger inlet valve 318 is closed, compression ratio valve 320 is closed, and movable wall 304 moves up to the top of cylinder 300. While movable wall 304 is moving up exhaust gases are moving through heat exchanger low-pressure side 20 and cooling while heating up heat exchanger high-pressure side 10 on their way out exhaust pipe 30. Also while movable wall 304 is moving up, it takes in fresh air through air inlet port 302. Power piston 306 continues down to the bottom of cylinder 300 and comes up again to about 15% of its upward travel (225°).

FIG. 8 shows that in cylinder 100 power piston 106 is at about 15% of its downward travel (45°). Heated air valve 114 is closing, low-pressure heat exchanger inlet valve 116 is closed, high-pressure heat exchanger inlet valve 118 is closing, compression ratio valve 120 is closed, and movable wall 104 is moving to the top of power piston 106.

In cylinder 300, there is a charge of fresh air between movable wall 304 and power piston 306 which is at about 15% of its upward travel (225°). Air inlet port 302 has just been recovered, heated air valve 314 is closed, low-pressure heat exchanger inlet valve 316 is closing, high-pressure heat exchanger inlet valve 318 is closed, compression ratio valve 320 is opening, and movable wall 304 is at the top of cylinder 300.

Between FIG. 8 and FIG. 5, in cylinder 100 expansion takes place. Heated air valve 114 is closed, low-pressure heat exchanger inlet valve 116 is closed, high-pressure heat exchanger inlet valve 118 is closed, compression ratio valve 120 is closed, and movable wall 104 is adjacent to the top of power piston 106. Power piston 106 and movable wall 104 move down to about 85% of power piston's 106 downward travel (135°), as power output takes place.

In cylinder 300 compression takes place. Air inlet port 302 is recovered, heated air valve 314 is closed, movable wall 104 is adjacent to the top of cylinder 300, low-pressure heat exchanger inlet valve 316 is closed, high-pressure heat exchanger inlet valve 318 is closed, and compression ratio valve 320 is open. Compression ratio valve 320 closes when the correct amount of air for the desired compression ratio is left in cylinder 300. Power piston 306 continues up in cylinder 300 to about 85% of its upward travel (225°).

### CONCLUSION

One advantage of the Warren Cycle Internal Combustion Engine With Heat Exchanger is that it can use the exhaust heat of all four cylinders to preheat the compressed fluid while using only one heat exchanger.

Another advantage of the Warren Cycle Internal Combustion Engine with Heat Exchanger is that it can be operated so that the charge is fully expanded.

I claim:

1. A two stroke, internal combustion, reciprocating engine having heat exchanger, a power output shaft, crankcase, and four similar working units, each working unit comprising:
a) a cylinder, closed at one end and containing an air inlet port and a movable power piston which moves in a reciprocating manner and is connected to said power output shaft;
b) a movable wall located within said cylinder and between said power piston and the top of said cylinder, said movable wall can be moved between said power piston and the top of said cylinder;
c) valves that direct the air flow from said cylinder through the high pressure side of said heat exchanger, and back into said cylinder at predetermined times during the cycle;
d) a valve that directs the air flow from said cylinder through the low pressure side of said heat exchanger and out the exhaust of said cylinder at predetermined times during the cycle;
e) an actuator means for moving said movable wall during predetermined times during the engine's operating cycle.

2. An engine as recited in claim 1 wherein said actuator means for moving said movable walls during predetermined times during the engine's operating cycle is a set of cams, push rods, and rocker arms.

3. An engine as recited in claim 1 wherein said actuator means for moving said movable walls during predetermined times during the engine's operating cycle is an electromagnetic actuator.

4. An engine as recited in claim 1 wherein said actuator means for moving said movable walls during predetermined times during the engine's operating cycle is a hydraulic actuator.

5. An engine as recited in claim 1 wherein the expansion ratio is different from the compression ratio.

6. An engine as recited in claim 1 wherein the position of said movable wall in said cylinder when said power piston recovers said air inlet port fixes the compression ratio.

7. A process for operating the engine of claim 1 having the following steps:
a) as said power piston uncovers said air inlet port and moves through its bottom dead center position back up to said air inlet port; air intake, exhaust, compression ratio adjustment, and exhaust takes place; as the exhaust passes through said heat exchanger, heat transfers to the compressed air of another cylinder;
b) exhausting of said cylinder continues until said movable wall reaches the top of said cylinder;
c) air in said cylinder is compressed;
d) as said power piston approaches the conclusion of the compression stroke, said movable wall moves away from its position adjacent to top of said cylinder toward said power piston, compressed air is forced from below said movable wall through said heat exchanger to above said movable wall, the compressed air is heated as it moves through said heat exchanger;
e) fuel is added and ignited;
f) said movable wall moves to the top of said power piston while said power piston continues its expansion stroke;
g) the cycle repeats.

8. A process for operating the engine of claim 1 having the following steps:
a) air intake and exhaust,
b) compression ratio adjustment by said movable wall,
c) compression at near adiabatic conditions,
d) heat added from the transfer of heat by said heat exchanger from the exhaust of one cylinder to the compressed air of another cylinder, and from burning fuel at near constant volume,
e) expansion at near adiabatic conditions,
f) the process repeats.

9. A two stroke, internal combustion, reciprocating engine having a heat exchanger, a power output shaft, crankcase, and two similar working units, each working unit comprising:
a) a cylinder, closed at one end and containing an air inlet port and a movable power piston which moves in a reciprocating manner and is connected to said power output shaft;
b) a movable wall located within said cylinder and between said power piston and the top of said cylinder, said movable wall can be moved between said power piston and the top of said cylinder;
c) valves that direct the air flow from said cylinder through the high pressure side of said heat exchanger and back into said cylinder at predetermined times during the cycle;
d) a valve that directs the air flow from said cylinder through the low pressure side of said heat exchanger and out the exhaust of said cylinder at predetermined times during the cycle;
e) an actuator means for moving said movable wall during predetermined times during the engine's operating cycle;

10. An engine as recited in claim 9 wherein said actuator means for moving said movable walls during predetermined times during the engine's operating cycle is a set of cams, push rods, and rocker arms.

11. An engine as recited in claim 9 wherein said actuator means for moving said movable walls during predetermined times during the engine's operating cycle is an electromagnetic actuator.

12. An engine as recited in claim 9 wherein said actuator means for moving said movable walls during predetermined times during the engine's operating cycle is a hydraulic actuator.

13. An engine as recited in claim 9 wherein the compressed volume is determined by having a valve that allows air to move out of the engine during compression.

14. An engine as recited in claim 13 wherein the expansion ratio is different from the compression ratio.

15. An engine as recited in claim 13 wherein the compression ratio valve fixes the compression ratio.

16. A process for operating the engine of claim 9 having the following steps:
a) as said power piston uncovers said air inlet port and moves through its bottom dead center position back up to said air inlet port; air intake and exhaust takes place; as the exhaust passes through said heat exchanger, heat transfers to the compressed air of another cylinder;
b) exhausting of said cylinder continues until said movable wall reaches the top of said cylinder;
c) air in said cylinder is compressed;
d) as said power piston approaches the conclusion of the compression stroke, said movable wall moves away from its position adjacent to top of said cylinder toward said power piston, compressed air is forced from below said movable wall through said heat exchanger to above said movable wall,
e) the hot compressed air is further heated by fuel being burned;
f) said movable wall moves to the top of said power piston while said power piston continues its expansion stroke;
g) the cycle repeats.

17. A process for operating the engine of claim 13 having the following steps:
a) air intake and exhaust,
b) compression ratio adjustment by said compression ratio valve,
c) compression at near adiabatic conditions,
d) heat added from the transfer of heat by said heat exchanger from the exhaust of one cylinder to the compressed air of another cylinder, and from said heater at near constant volume,
e) expansion at near adiabatic conditions,
f) the process repeats.
